(19) United States
(12) Patent Application Publication
(10) Pub. No.: US 2019/0370549 A1
(43) Pub. Date: Dec. 5, 2019

(54) AUGMENTED AND VIRTUAL REALITY OPERATIONS SYSTEM

(71) Applicant: VISA INTERNATIONAL SERVICE ASSOCIATION, San Francisco, CA (US)

(72) Inventors: Chackan Lai, San Francisco, CA (US); Andrew Sierra, Foster City, CA (US)

(73) Assignee: VISA INTERNATIONAL SERVICE ASSOCIATION, SAN FRANCISCO, CA (US)

(21) Appl. No.: 16/485,125

(22) PCT Filed: Feb. 10, 2017
(86) PCT No.: PCT/US2017/017358

§ 371 Date: Aug. 9, 2019

(51) Int. Cl. G06K 9/00; G06T 19/00; G06Q 20/32; G06F 3/01; G06Q 30/06; H04W 4/021; G06F 21/32

(52) U.S. Cl. CPC G06K 9/00671; G06T 19/006; G06Q 20/3274; G06F 21/32; G06Q 30/0601; H04W 4/021; G06F 3/017

(57) ABSTRACT

A virtual reality (VR) device communicates with a projection display platform to establish a secure communication session related to an exchange of data. The session may be established using a QR code presented by the projection display platform that is received at the VR display. The VR device captures a voice or gesture related to the pending transaction and relays an appropriate instruction to the projection display platform for processing the pending transaction.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Hardware for processing a transaction requires physical presentation of a payment instrument or tokenized device at the point of sale. The physical interaction with the hardware may be difficult or impossible for some people. In some cases, there may be situations whereby it is impossible for any form of physical interaction between the entities engaging in the transaction either due to limitations of the person involved in the transaction or a situation they may find themselves in.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

An AR/VR device exchanges handshake data with a projection display platform via a wireless connection. The handshake data confirms hardware compatibility between the device and the platform for completing approvals via the AR/VR device. After compatibility is established, the platform may send transaction and, in some embodiments virtual reality image data, for presentation to a user of the AR/VR device as a projected VR image. The user may interact with the projected VR image in order to approve or reject a payment, or to select a payment vehicle. If approved, the AR/VR device may encrypt the response for sending to the projection display platform as well as generate a cryptogram for use in tokenized transactions. The interaction with the projected VR image avoids the need for the user to physically interact with the point of sale device such as proximity presenting a payment card, providing a signature, or co-location of a smartphone with a terminal.

### BRIEF DESCRIPTION OF THE DRAWINGS

FIG. 1 is a block diagram of projection display platform in communication with an AR/VR device in accordance with the current disclosure;

FIG. 2 is a block diagram illustrating a system incorporating the projection display platform and AR/VR device of FIG. 1; and

FIG. 3 is a flow diagram of an exemplary method of operating the system of FIG. 2.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

A projection display platform and an AR/VR device are configured for automatic discovery and protocol negotiation so that transactions can be viewed and approved or rejected by a user without bringing a payment card or smartphone into contact or close physical proximity with a point of sale device. Instead, the projection display platform and the AR/VR device communicate transaction details, selection of payment instruments, approvals, and when available, tokenized card numbers and transaction-related cryptograms, via a wireless connection so that the user only need interact with the AR/VR device to complete a transaction.

FIG. 1 is a block diagram generally illustrating a representative AR/VR device 104 and representative projection display platform 106. The projection display platform 106 may include a central processing unit (CPU) 108 that is operatively coupled to a wireless communication device 110, an input device 112, cryptographic processor 114, and a memory 116.

The wireless communication device 110 may send and receive signals with the AR/VR device 104. In various embodiments, the wireless communication device 110 may be a radio frequency device, such as an 802.11 (WiFi) device or a Bluetooth™ device. In other embodiments, the wireless communication device 110 may be an infrared or other light frequency-based device. The wireless communication device 110 may support two functions, among others. The first may be to broadcast a beacon signal that indicates the projection display platform 106 supports AR/VR transaction capabilities. The second may be the communication of data with the AR/VR device 104 during transaction processing. Of course, other functions may be supported by the wireless communication device 110 such as health and diagnostic reporting with a base unit, or other business and maintenance functions.

The beacon signal may be a coded message on a normal wireless channel, such as a character set appended to a service set identifier (SSID) in WiFi or a Bluetooth service discovery protocol (SPD). In other embodiments, the capability for supporting AR/VR may be broadcast during a protocol handshake or polling message. While there is no requirement that the beacon signal must be broadcast from the projection display platform 106 as opposed to being broadcast from the AR/VR device 104, it is anticipated that for reasons of battery life it may be less common for the AR/VR device 104 to broadcast a beacon signal. In an instance where the AR/VR device 104 may broadcast a beacon signal, the process described below is essentially followed with the handshake process starting from the opposite party. The projection display platform 106 may also include an input device 112 that may be used for capturing transaction details. In an illustrative embodiment, the input device may be a barcode scanner while in another embodiment the input device may simply be a keyboard or touchscreen for entry of text and data.

A cryptographic processor 114 may be used for authentication and encryption as related to transaction security. Particularly in cases where the AR/VR device 104 has a an electronic wallet, a mutual authentication may be based on wallet provider issued cryptographic keys or underlying payment card issuer cryptographic keys. The cryptographic processor 114 may also be used to store master keys and develop derived keys for use in transaction-oriented cryptogram generation for those instances where such a cryptogram is not generated in the AR/VR device 104.

The memory 116 may be any of numerous known physical memory devices and may include a combination of volatile and nonvolatile memory but does not include carrier wave or propagated media-type memories. The memory 116 may include both data and executable code stored in a number of modules that may include an AR data formatting module 118, a transaction processing module 120, a communication/security protocol module 122, and AR/VR image files 124. The AR data formatting module 118 may include data and executable code that receives transaction data from the input device 112 and extracts and/or reformats the data for use by the AR/VR device 104. For example, after reading a universal product code (UPC) for a particular product, the AR data formatting module 118 may look up relevant information for that UPC including, for example, a price, an image, extended warranty data, related discount offers, etc. Both the text and image information may be formatted for color, depth, or stereoscopic effect for presentation at the AR/VR device 104.

The transaction processing module 120 may have executable code that supports formatting of messages and communication with a processor 130 such as a merchant acquirer or issuer. The transaction processing module 120 may also manage message formatting and content passed between the projection display platform 106 and the AR/VR device 104. The communication and security protocol module 122 may manage communication protocols for various external interactions and may also include security protocol management in conjunction with the cryptographic processor 114.

AR/VR image files 124 may include previously prepared image files for use by the AR/VR device 104 for presentation to a user 102. Images stored in the AR/VR image files may also be generated in real time during an interaction. For example, information such as product images may be retrieved and then a stereoscopic image may be generated and stored for transfer to and use by the AR/VR device 104.

Turning to the AR/VR device 104, the AR/VR device 104 may be a standalone device that is carried or worn by a user 102. In other embodiments, the AR/VR device 104 may be part of another personal apparatus. For example, a personal mobility scooter or powered wheelchair may include an AR/VR capability using the described technology for supporting interactions at various embodiments of projection display platforms 106, such as point-of-sale devices.

The AR/VR device 104 may include a CPU 132 that executes instructions stored in a memory 144. The AR/VR device 104 may also include a wireless communication device 134 that is configured for communication with the wireless communication device 110 of the projection display platform 106. An AR/VR projector 136 may project images into a field of view of a user 102.

Augmented reality (AR) may be generally understood to be the ability to project information such as images or text over a user's direct view of an area. Virtual reality (VR) may be generally understood as creating a visual environment that replaces a user's direct view of an area with a captured image that is projected in the user's field of view. This scene may, in fact, be the actual environment in which the user 102 is engaged with additional information being made available. For the purpose of this disclosure, is it not significant if the AR/VR device 104 is an augmented reality device, such as Google Glass or a virtual reality device such as Oculus Rift. As long as the user 102 is able to have a sense of his or her actual location and be able to interact with the surrounding physical environment, the distinction between AR and VR is not of importance.

A cryptographic processor 138 may be used to generate derived keys, sign/verify, encrypt, and decrypt various data items as part of mutual authentication with the projection display platform 106, data security for interactions (if any) with the downstream processor 130, generation of cryptograms for transaction packages, etc. One or more sensors 140 may be used to detect an area around the user 102, particularly to capture images of the immediate environment as well as to detect movement in the three dimensional (3D) space in the user's field of view. The detection of movement can be used for making selections and indicating approval or rejection of an offer, as discussed more below as well as being used to initiate payment and authenticating the user to the platform of approval of transaction.

The sensor array 140 may have the ability to also track the user's facial expression as well as iris movement and focus as a component of initiating the selection, payment and/or authentication process.

A microphone 142 may be used as one of the sensors 140 but is illustrated separately to highlight that both audio and spatial sensors may be used in gathering information from the environment or from the user 102. The memory 144 may include a number of modules of either executable code, data, or both. These modules may include a communication and security protocol module 146 that may perform similar functions to the corresponding communication/security protocol module 122 in the projection display platform 106. An AR/VR projection module 148 may gather image data from the sensors, from local memory, from the AR/VR image files 124 of the projection display platform 106 and manage the formatting required, if any, and the placement of image data in the user's field of view.

Card and token data 150 may be a local repository for a user's wallet or for other information such as a personal account number (PAN) for a financial instrument that the user 102 may employ for completing a transaction, reward account registration, etc. A gesture recognition module 152 may interpret signals received via either the sensors 140 or the microphone 142 into instructions from the user 102. This sensing process may be activated when a transaction has reached a point where a response from the user 102 is expected, such as after an AR/VR image has been projected into the user's field of view. These gestures may include a head nod, a wave of a hand in the field of view, a touch of a hand or instrument to a projected image, or recognition of a predetermined audio signal.

The memory 144 may also include cryptographic matter 154, such as master keys, derived keys, certificates, cryptograms or similar data used in the completion of an authentication function or a transaction. In an embodiment, the cryptographic matter 154 may be in a secure area of memory 144, for example, a secure element, or may itself be locally encrypted by the cryptographic processor 138.

An authentication and transaction security module 156 may include executable instructions and policy data for recognizing, enforcing, and enacting security protocols relevant to a particular phase of an interaction with the projection display platform 106 or a downstream processor 130 such as a merchant acquirer.

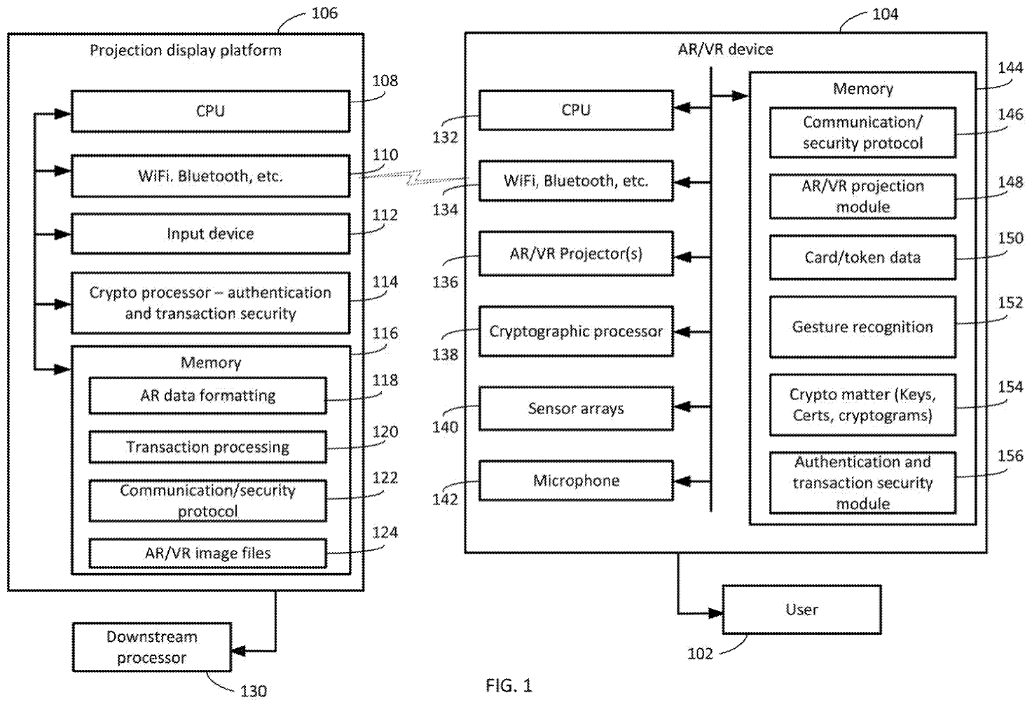

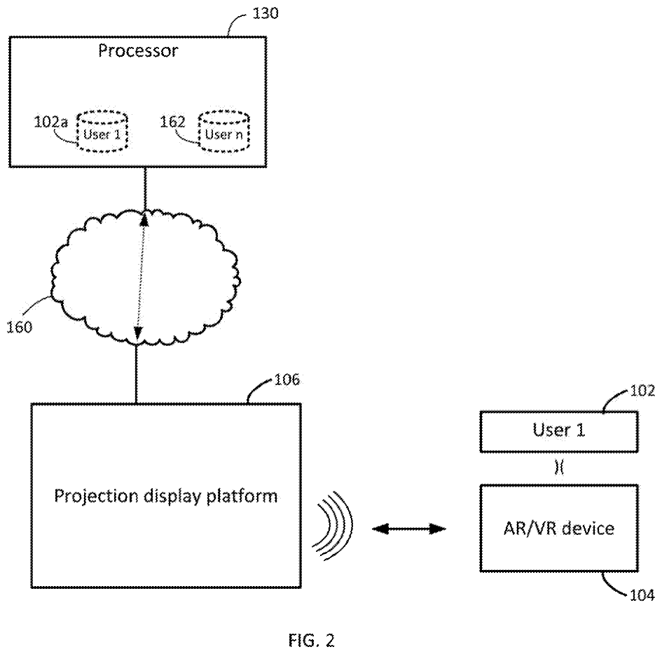

An overall view of the system environment for the AR/VR device 104 and the projection display platform 106 is illustrated in FIG. 2. A user 102 is associated with an AR/VR device 104. As discussed above, the user 102 may wear or carry the AR/VR device 104 to allow the AR/VR device 104 to project images into the line of sight of the user as may be accomplished by glasses, a headset, or a more advanced technique such as 3D projection. In an embodiment where the user 102 uses a motorized chair or similar device, the projection may be onto a transparent or semi-transparent screen. The AR/VR device 104 supports projection of images in the user's field of view and captures input from the user 102 either via gesture or voice command.

The projection display platform 106 may be in wireless communication with the AR/VR device 104 via the respective wireless communication devices 110, 134. The projection display platform 106 may broadcast a beacon signal indicating that AR/VR operation support is available so that the AR/VR device 104 can connect when it is within range. The projection display platform 106 also may communicate via a network 160, either a private network such as a banking network or a public network such as the Internet. A processor 130 may be a merchant acquirer, an issuer, a token service provider, or another entity that participates in transaction processing. The processor 130 may be an endpoint or may simply be an intermediary in the full transaction approval process. The processor 130 may have stored information about the user 102 in the form of user data 102a. The processor 130 may also include user data 162 for a plurality of other users that is either explicitly transferred there or by obtained by gathering information over a period of time through continued interactions with the projection display platform 106 and other similar platforms (not depicted).

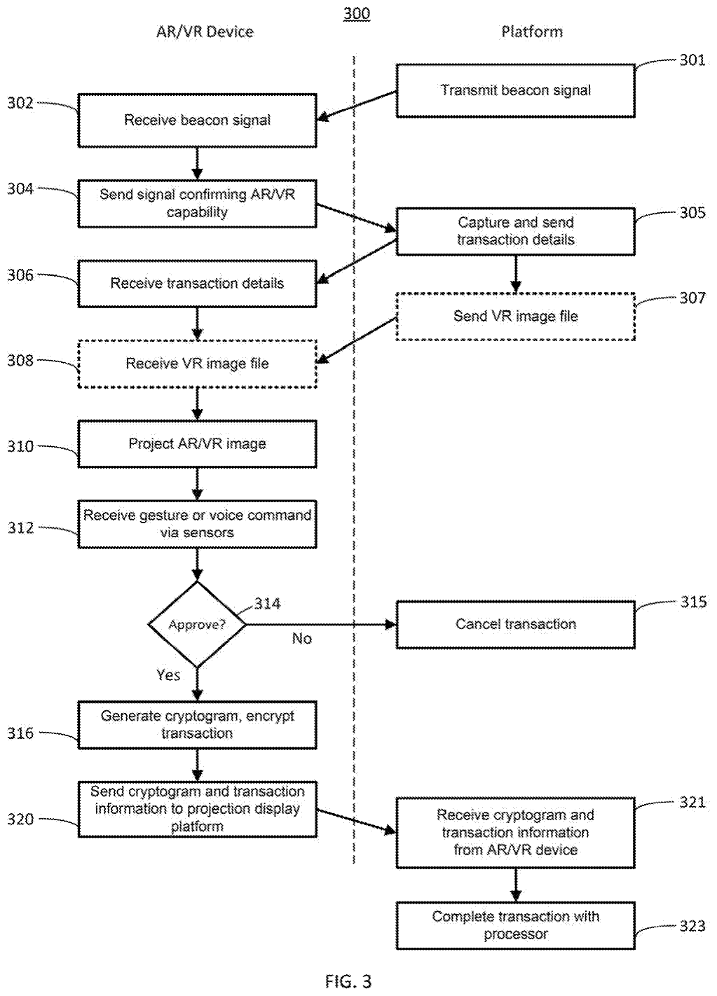

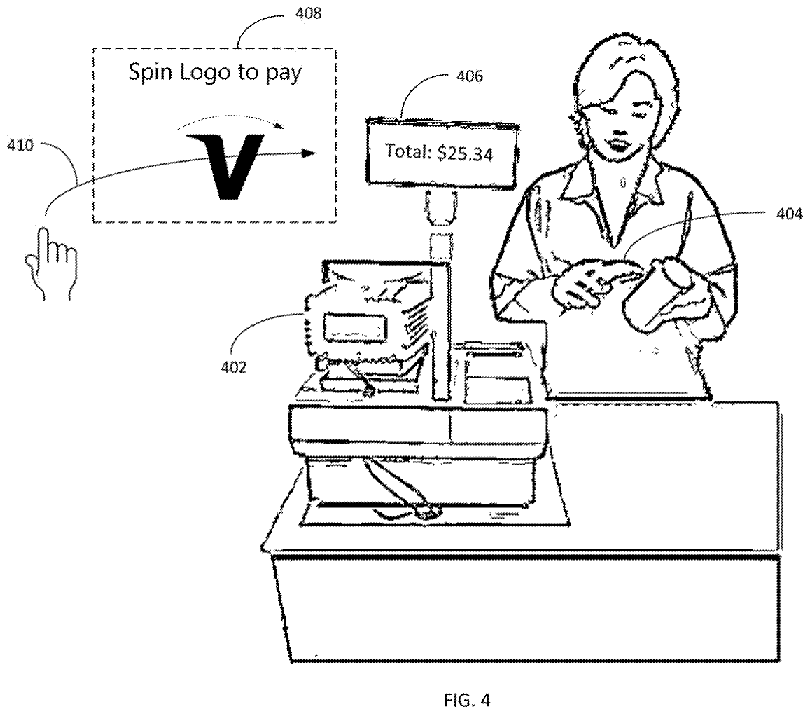

FIG. 3 is an flowchart 300 of exemplary interactions between the projection display platform 106 and the AR/VR device 104. In this bounce diagram, activity performed by the projection display platform 106 are depicted on the right side of the flowchart while activity performed by the AR/VR device 104 are shown on the left side of the flowchart. In the illustrated embodiment, the projection display platform 106 broadcasts a beacon signal at block 301. In some embodiments, the beacon signal may be continuously broadcast, while in others the beacon signal may be send at an interval. In other embodiments, the beacon signal may only be broadcast upon when a user 102 is sensed or by an action of a person, such as a store clerk when the user 102 is present. As mentioned above, other methods for discovering AR/VR interactive capabilities may be used, such as the AR/VR device 104 sending a request signal.

In the illustrated embodiment, the AR/VR device 104 receives the beacon signal at block 302 and responds with a signal confirming AR/VR capability at block 304. A protocol negotiation may be held between the two parties to determine capabilities and formats as well as to perform a mutual authentication using any of a number of known protocols such as ISO 14443. Such a protocol negotiation and/or mutual authentication may be performed initially or at some other point in the process.

After the mutual authentication, or in some cases without such a mutual authentication, session keys may be derived at both the AR/VR device 104 and the projection display platform 106. These session keys may be used to encrypt data sent wirelessly between the two machines to prevent eavesdropping and when used with a key-based mutual authentication, to reduce the risk of a man-in-the-middle attack.

At block 305, the projection display platform 106 may capture, for example, using the input device 112, transaction details. In an embodiment, the transaction details may include scanning one or more product barcodes or receiving a request for services. These transaction details may be sent to the AR/VR device 104 and received at block 306 by the AR/VR device 104. In another embodiment, the projection display platform 106 may display a quick response (QR) code that is observed at the AR/VR device 104 by one of the sensors 140, such as a camera, so that the transaction details may be decoded from the QR code.

In an embodiment, at block 307, the projection display platform 106 may send an AR/VR image file that is received at block 308 by the AR/VR device 104. As discussed above, the AR/VR image file may be related to the transaction being processed, either with images related to a product or service being purchased or with payment vehicle graphics extracted from a wallet account or another online resource as identified during the mutual authentication discussed above. In an embodiment, the AR/VR device 104 may have limited memory for long-term storage of potentially large 3D image files so that even what may be considered common images, such as brand logos representing different payment vehicles, may not be routinely stored on the AR/VR device 104 but rather may be downloaded as needed at the time of a transaction.

One or more AR/VR images may be projected, at block 310, into the user's line of sight and may include an image of a product, transaction details such as purchase totals, or one or more payment instruments for approval and selection by the user 102. At block 312, the user 102 may indicate with a gesture or a spoken command with regard to these choices. For example, in an embodiment, the user 102 may approve of the purchase total after reviewing the projected image of the transaction details by saying the phrase “approved for payment” or a similar word or phrase. In such an embodiment, the user 102 may then be asked to select a payment instrument from a plurality of payment instruments. For example, the payment images may be presented in VR space and the user may use a hand gesture, head motion, or spoken command to move through the available options and make the selection. In an embodiment, the payment instruments may be presented in a carousel that “spins” in order to allow viewing and selection. The user 102 may perform the selection by simply “touching” the projected image corresponding to the chosen payment instrument. In various embodiments, simply touching or “swiping” a payment card logo may be all that is required to approve a transaction, for example, when the transaction details are visible at the projection display platform 106. The virtual “touch” or other gesture may be recognized by the sensors 140 of the AR/VR device 104 by monitoring for motion in the field of view, especially in the area (or frustum) covered by the projected image. The transaction receipt may be printed and included with the purchased items or may be sent electronically to a wallet account or email address.

The gesture used to approve the transaction may then be verified against a predetermined template of gestures that could be configured during the initial enrollment of the AR/VR device 104. That is, in an embodiment, rather than a simple gesture, such as pointing to the payment instrument, the transaction approval may be a complex gesture that is verifiable by the sensor array 140 as a further authentication. In another embodiment, the authentication may involve an iris scan or other biometric indicator. This recognition and verification of the gesture or biometric may be performed by the authentication and transaction security module 156 as an additional layer of security for the transaction.

If the transaction is not approved, the “no” branch may be taken from block 314 to block 315 and the transaction may be terminated. If the transaction is approved, the “yes” branch may be taken from block 314 to block 316 where, in an embodiment, a cryptogram may be generated for use in completing the transaction. The cryptogram, the same as or similar to cryptograms used with smart card payments, may be used in conjunction with a tokenized card number to reduce the risk of card fraud. This cryptogram may, in some embodiments, also incorporate the authentication information obtained above. In other embodiments, a cryptogram may not be generated at the AR/VR device 104 and simple payment instrument values may be used to complete a transaction. At block 320 the transaction-related information captured or generated at the AR/VR device 104 may be sent to the projection display platform 106.

At block 321, the approval information such as the cryptogram and token may be passed to the projection display platform 106. In an embodiment, additional details may be added to the information received from the AR/VR device 104 and the package may be sent to the processor 130 for completion of the transaction according to current policies at block 323. For example, the transaction data may be passed to a token service provider where the token may be replaced by a issuer PAN and the transaction passed to the appropriate issuer for ultimate approval of the transaction. Such approval may be passed back to the terminal to allow completion of the transaction. In an embodiment, the approval details, similar to those that might appear on a printed receipt may be transferred to and stored at the AR/VR device 104.

FIG. 4 illustrates an exemplary scene viewed by a user 102 at a projection display platform 106, in this embodiment shown as a point of sale (POS) device 402. In this example, a product is scanned by a bar code reader 404 and a total for a purchase transaction may be displayed on a screen 406 of the POS device 402.

At this point, as discussed above, the projection display platform 106 may send the transaction details and VR images to the AR/VR device 104 via a wireless connection. In an alternate embodiment, the screen 406 may display a QR code with details of the transaction so that the AR/VR device 104 may capture the transaction details via a camera included as one of the sensors 140.

An image 408 may be projected via the AR/VR device 104 into the user's field of view, in this case, a logo of a payment instrument and an instruction to the user 102 for how to proceed. When the user 102 gestures across the projected image 408, illustrated by motion 410, the sensors 140 of the AR/VR device 104 may correlate the region and direction of motion, in this case by the user's hand, with the location of the projected image in order to infer the approval of the transaction. Processing may continue as described above.

The apparatus and method described above overcome a technical challenge, in one embodiment, of improving accessibility at a projection display platform 106 so that a user 102 is not required to approach or interact with the projection display platform 106 either by manually swiping, dipping, or tapping a payment instrument to the projection display platform 106 or by entering a signature. The transaction elements required for safe and secure processing are maintained while the need for immediate proximity between the payment instrument and the projection display platform 106 are reduced or eliminated.

The disclosed apparatus and method benefit a merchant by extending the number of ways to service a customer in a secure fashion. A user 102 also benefits by having additional options for using an AR/VR device 104 for enhancing a shopping experience, not only by being able to provide real time advice when selecting products but also by reducing the physical requirements at the projection display platform 106 when checking out.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A system for gesture-based or voice-based approval comprising:
an augmented reality/virtual reality (AR/VR) device worn by a user, the VR device including:
a first processor;
a first wireless communication device that sends and receives signals with a projection display platform, the first wireless communication device that broadcasts a signal with an identifier that indicates an AR/VR transaction capability when proximate the projection display platform;
a virtual reality projector associated with the display platform that projects a virtual image in a field of view of the user;
a first cryptographic processor that supports mutual authentication with the projection display platform and encrypts transaction data;
one or more sensors that detect a user gesture, facial expression, iris focus, or voice command interacting with the virtual image; and
a memory storing executable code and configuration data, the executable code for use by the first processor to:
recognize the projection display platform;
project an augmented reality (AR) image corresponding to transaction information received from the display platform;
recognize an approval gesture or voice command responsive to projecting the AR image, the approval gesture or voice command indicating approval of a transaction described by the transaction information; and
send transaction information and a transaction-related cryptogram to the projection display platform responsive to the approval gesture or voice command; and
the projection display platform including:
a second processor;
a second wireless communication device that broadcasts a beacon signal indicating AR/VR transaction capability and provides two-way communication with the first wireless communication device of the VR device;
an input device for capturing transaction information;
a second cryptographic processor that supports mutual authentication with the AR/VR device and encrypts transaction data; and
a memory storing executable code and data, wherein the executable code causes the second processor to:
receive the transaction information via the input device;
recognize an augmented reality (AR) capability in the VR device when the VR device is proximate the projection display platform;
send the transaction information to the VR device; and
receive transaction information from the VR device for use in completing a transaction.

2. The system of claim 1, wherein the first cryptographic processor encrypts the transaction information and the cryptogram before sending the transaction information to the projection display platform.

3. The system of claim 1, wherein the executable code causes the projection display platform to send a graphics file to the VR device, the graphics file including an image associated with the transaction information.

4. The system of claim 3, wherein the graphics file further includes images for accepted payment brands.

5. The system of claim 3, wherein the VR device, prior to sending the transaction information to the projection display platform performs an authentication of a user of the VR device via one of the one or more sensors.

6. The system of claim 5, wherein the authentication of the user is one of a voice print or an iris scan.

7. The system of claim 1, wherein the one or more sensors includes a motion detector.

8. The system of claim 1, wherein the one or more sensors includes a camera.

9. The system of claim 1, wherein the first wireless communication device is a radio frequency device supporting one of a WiFi protocol and a Bluetooth protocol.

10. The system of claim 1, wherein the first wireless communication device is an infrared device.

11. The system of claim 1, wherein the memory further stores the transaction information.

12. The system of claim 1, wherein the projection display platform presents a quick response (QR) code that is scanned by the VR device, the QR code returned to the projection display platform by the VR device as the identifier.

13. A method of communicating between a virtual reality (VR) device and a projection display platform, the method comprising:
storing, at the projection display platform, transaction information corresponding to a transaction, the transaction information gathered at the projection display platform;
moving the VR device into proximity of the projection display platform;
broadcasting, from the VR device, a signal that indicates a wireless transaction capability;
receiving, at the projection display platform, the signal from the VR device;
activating a protocol for transaction approval, the protocol including:
transmitting the transaction information from the projection display platform to the VR device;
presenting, via the VR device, the transaction information;
receiving, at the VR device via a sensor, an indicator corresponding to an instruction related to processing the transaction information;
authenticating, at the VR device via capture by the sensor array, gestures of the user; and
sending the instruction from the VR device to the projection display platform; and
processing, at the projection display platform, the transaction according to the instruction received from the VR device.

14. The method of claim 13, further comprising: performing a mutual authentication between the VR device and the projection display platform.

15. The method of claim 14, wherein transmitting the transaction information from the projection display platform to the VR device comprises transmitting the transaction information over an encrypted channel using session keys developed during the mutual authentication.

16. The method of claim 14, further comprising, scanning at the VR device, a quick response (QR) code presented by the projection display platform, the QR code being part of the mutual authentication between the VR device and the projection display platform.

17. The method of claim 13, further comprising:
presenting, at the VR device, an image corresponding to one or more payment instruments; and
receiving, via the sensor, a second physical movement corresponding to a selection of one of the one or more payment instruments.

18. The method of claim 13, wherein the projection display platform sends an image file to the VR device, the image file modified with the transaction information, the image file for use by the VR device when presenting the transaction information.

19. A method of communicating between a virtual reality (VR) device and a projection display platform, the method comprising:
storing, at the projection display platform, transaction information corresponding to a transaction, the transaction information gathered at the projection display platform;
displaying, at the projection display platform, a quick response (QR) code corresponding to the transaction information;
capturing, at the VR device, the QR code and extracting transaction data from the QR code;
activating a protocol for transaction approval, the protocol including:
establishing an encrypted session between the VR device and the projection display platform using, at least in part, information from the QR code;
presenting, via the VR device, the transaction information;
receiving, at the VR device via a sensor, an instruction related to processing the transaction information; and
sending the instruction from the VR device to the projection display platform via the encrypted session; and
processing, at the projection display platform, the transaction according to the instruction received from the VR device.

20. The method of claim 19, further comprising, authenticating, at the VR device via capture by the sensor array, gestures of the user.
